(19) United States
(12) Patent Application Publication
(10) Pub. No.: US 2025/0224064 A1
(43) Pub. Date: Jul. 10, 2025

(54) LATERAL SEWER PIPE COUPLING

(71) Applicant: Tim Sauve, Hamilton (CA)

(72) Inventor: Tim Sauve, Hamilton (CA)

(21) Appl. No.: 19/006,767

(22) Filed: Dec. 31, 2024

Related U.S. Application Data
(60) Provisional application No. 63/619,061, filed on Jan. 9, 2024.

(51) Int. Cl. F16L 41/14; E03F 3/04

(52) U.S. Cl. CPC F16L 41/14; E03F 3/04

(57) ABSTRACT

Provided is a coupling for providing a tap off a main pipe and a method for deploying and manufacturing the same. The coupling includes an insert for partial insertion into the main pipe. The insert includes a coupling pipe for providing a flow conduit and an anchor pivotably connected to the coupling pipe at an insertion end. The anchor is configured to retract when inserted through an opening in the main pipe and deploy to a deployed configuration once inserted. In the deployed configuration the anchor extends radially from the coupling pipe for engaging an interior surface of the main pipe and anchoring the coupling to the main pipe when the insert is drawn outward by a securing force. At least one anchor is sufficiently rigid and fixed from pivoting past the deployed configuration to withstand forces for anchoring the coupling to the main pipe.

### TECHNICAL FIELD

The present disclosure generally relates pipe systems and particularly to assemblies and methods for connecting pipes.

### BACKGROUND

Pipe systems, such as sewer systems, typically include lateral pipes that branch off main pipes. A lateral pipe may provide a connection between buildings and the main pipe. The lateral pipe and main pipe may also be referred to as the branch pipe and trunk pipe respectively (or just branch and trunk). Connections between the lateral and main pipes are desired to be substantially watertight to prevent or mitigate leakage around the outside of the connection. In existing systems, adding a connection includes cutting a hole in the main pipe with a diameter large enough to receive the lateral pipe. To maintain the water tightness of the connection, a seal must be formed while making the connection.

In some existing systems, the lateral connection and seal is made from inside the main pipe. However, at the time of connection, access to the interior of the main pipe can often be obstructed or restricted for example where a building or other structure needs to tap into covered or buried main pipes. These obstructions or restrictions may prevent or hinder implementing connecting and sealing mechanisms also referred to collectively as a coupler.

In some existing systems, the coupler includes an anchor of a securing mechanism for securing the coupler to the interior of the main pipe and/or sidewall of the hole (formed by the thickness or the pipe) by a fastener of the securing mechanism. Where access to the interior of the pipe is restricted to the hole cut in the main pipe, the anchor may be passed through the hole into the interior of the main pipe.

In some existing systems the anchor is resiliently deformable for passing fully or partially through the hole when deformed by a force. When the force is released, the resilient anchor returns to its original form and is secured. The resilient anchor may also serve as the seal. This dual sealing and anchor functionality necessarily requires a specialized resilient anchor rather than an anchor paired with a generic seal. Specifically, the resilient anchor necessarily requires a profile (i.e. circumference) corresponding to the full profile (i.e. circumference) of the hole and configured to fit through the hole when deformed and a material composition resilient enough to anchor the coupler but pliable enough to be sufficiently deformed. This necessary specialization may present costly and restrictive inventory considerations especially for in-field installations common in pipe work.

Furthermore, applying securing forces to a resiliently deformable anchor may require precision. Too little force may not secure the connection or create the seal. Too much force may cause deformation or displacement of the deformable anchor that disrupts the connection or seal. The skill, training, and focus required to apply such precision may be costly and create a failure risk. These risks are exacerbated interference with inspecting the anchor for improper installation due to the limited access to the interior of the pipe. These issues may result in costly repairs or undesirable results particularly when the issues only fully manifest after available access to the connection is removed.

In some of these existing systems, the anchor may be solid. The solid anchor may be smaller than the hole span in a first dimension for passing through the hole in a first orientation and larger than the hole span in a second dimension for interfering with the interior of the pipe in a second orientation to prevent removal of the securing mechanism from the pipe. The installation of either the resilient or solid anchor may be cumbersome as the anchor necessarily must be held from being lost in the interior of the main pipe prior to securing the anchor with the fastener. This includes holding the anchor while passing it through the hole and while securing the fastener. Mechanisms dedicated solely to this purpose may be costly, limiting, or undesirable. For example, specialized anchor insertion tools may be used which carry purchase and maintenance costs. In some existing systems the anchor may be specially configured to grip the hole, adding to the specialization and inventory costs described below. In still other existing systems, installers may be expected to hold the anchor either through the hole or other access which may be significantly limiting and/or require undesired skill or effort. Furthermore, the risk of dropping the anchor into the main pipe with any of these pre fastening retention methods is substantial. In addition to losing the anchor or the cost of retrieval, this risk may be of particular concern where the presence of an anchor loose in the pipe system could cause damage or presents a physical or environmental hazard.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

Accordingly, there is a need for apparatuses and methods for connecting pipes which overcome difficulties of existing pipe connections.

### BRIEF DESCRIPTION OF THE DRAWINGS

The drawings included herewith are for illustrating various examples of articles, methods, and apparatuses of the present specification. In the drawings:

FIG. 1 is a block diagram of a pipe system including a coupling 110, according to an embodiment;

FIG. 2 is a main pipe axial view of the pipe system of FIG. 1 with the coupling in an inserted configuration, according to an embodiment;

FIG. 3 is a main pipe side view of the pipe system of FIG. 1 with the coupling in an installed configuration, according to an embodiment;

FIG. 4A is top perspective view schematic of the coupling of FIG. 1, according to an embodiment;

FIG. 4B is bottom perspective view schematic of the coupling of FIG. 1, according to an embodiment;

FIG. 4C is top view schematic of the coupling of FIG. 1, according to an embodiment;

FIG. 4D is bottom view schematic of the coupling of FIG. 1, according to an embodiment;

FIG. 4E is first side view schematic of the coupling of FIG. 1, according to an embodiment;

FIG. 4F is second side view schematic of the coupling of FIG. 1, according to an embodiment;

FIG. 5A is a side view schematic of the insert of FIG. 1, according to an embodiment;

FIG. 5B is a side view schematic of the seal of FIG. 1, according to an embodiment;

FIG. 5C is a cross-sectional side view of the fastening member of FIG. 1, according to an embodiment;

FIG. 6 is a flow diagram of a method of installing the coupling of FIG. 1, according to an embodiment; and

FIG. 7 is a flow diagram of a method of manufacturing the coupling of FIG. 1, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

A description of an embodiment with several components in contact or connection with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The present disclosure provides a coupling for enabling physical and fluidic connection of a lateral pipe to a main pipe of a pipe system, such as a sewer pipe system. Further provided are methods of manufacturing the coupling and installing the coupling, also known as tapping the main pipe. The coupling provides a substantially watertight tap or port off of the main pipe for connecting the lateral pipe. It will be appreciated that “watertight” as referred to herein is directed to the coupling's quality to resist leakage at the coupling connection of any substantially fluid substance (i.e. gas or liquid) including but not limited to water. The coupling is suitable for installation in environments where the access to the interior of the main pipe is restricted. For example, the coupling can be installed where there is no secondary or human access to the interior of the main pipe such that access to the interior of the main pipe is restricted to a hole in the main pipe for the coupling.

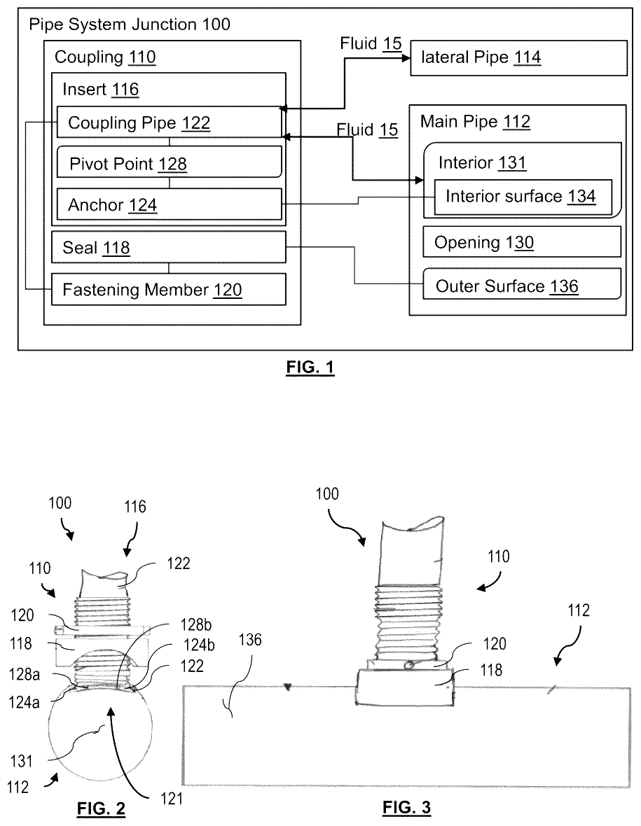

Referring to FIG. 1, shown therein is a block diagram of a pipe system 100 including a coupling 110, according to an embodiment. Referring also to FIGS. 2 and 3, shown therein is a main pipe axial view and a side view schematic, respectively, of the pipe system 100 including the coupling 110 in an inserted and an installed configuration, respectively, according to an embodiment.

The coupling 110, in an installed configuration further described below, provides a tap off a main pipe 112. The tap may be for physically and fluidically connecting an attachment such as a lateral pipe 114, valve or faucet to the main pipe 112. It will be appreciated that while the pipes 112 and 114 are described as “main” and “lateral” these terms are to distinguish between the pipes 112 and 114 and are not intended to be descriptive of any particular aspects of the pipe. The pipes 112 and 114 may be any pipe for providing a flow conduit for a fluid 115. The fluid 115 may be an substance that flows or travels through the pipe system 100 such as water, sewage, or gas.

In the installed configuration, the coupling 110 directs flow of the fluid 115 between the main pipe 112 and the lateral pipe 114. The coupling 110 is secured to the main pipe 112 and protrudes beyond and outer surface 136 of the main pipe 112. The protrusion of the coupling 110 beyond the outer surface 136 of the main pipe 112 serves as a tap or port enabling the physical and fluidic connection of the lateral pipe 114 to the main pipe 112. The coupling 110, in the installed configuration is disposed at an opening 130 in the main pipe 112. The opening 130 may also be referred to as hole 130. The opening 130 is created in the main pipe for enabling the flow of the fluid 115 between the main pipe 112 and the lateral pipe 114.

The opening 130 also provides access to the interior 131 of the main pipe 112. The access created by the opening may be limited to opening configurations suitable for securing the coupling 110 to the main pipe 112 and sealing the connection, further described below. It will be appreciated that access to the interior 131 of the main pipe 112 other than via the opening 130 may be undesirable, restricted, or unavailable. For example, creating additional access may be costly and expose the pipe system to risks such as those associated with securing this additional access against leakage. Existing additional accesses points such as open ends of the main pipe 112 or manholes may be obstructed (i.e. capped, buried, inoperable, etc.) or prohibitively inaccessible (to far away, unsafe, etc.). Furthermore, the main pipe 112 configuration or dimensions, such as the inner pipe diameter, may be inconsistent with secondary access. Therefore, it is beneficial to have a coupling 110 that may be provided using only the access provided by the opening 130.

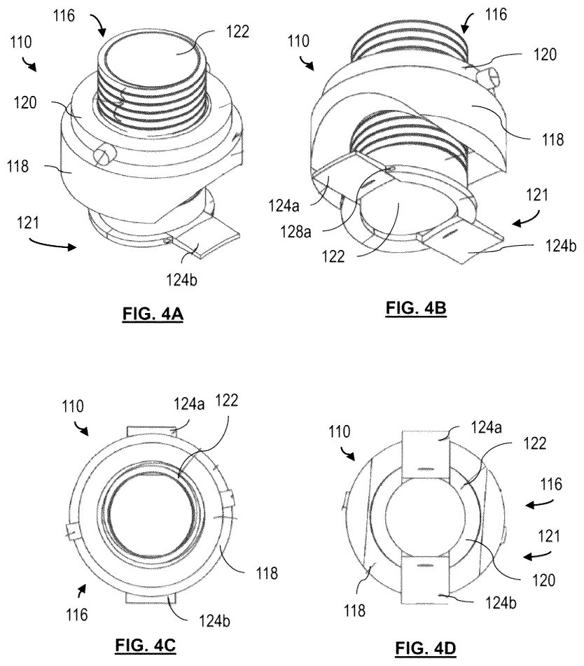

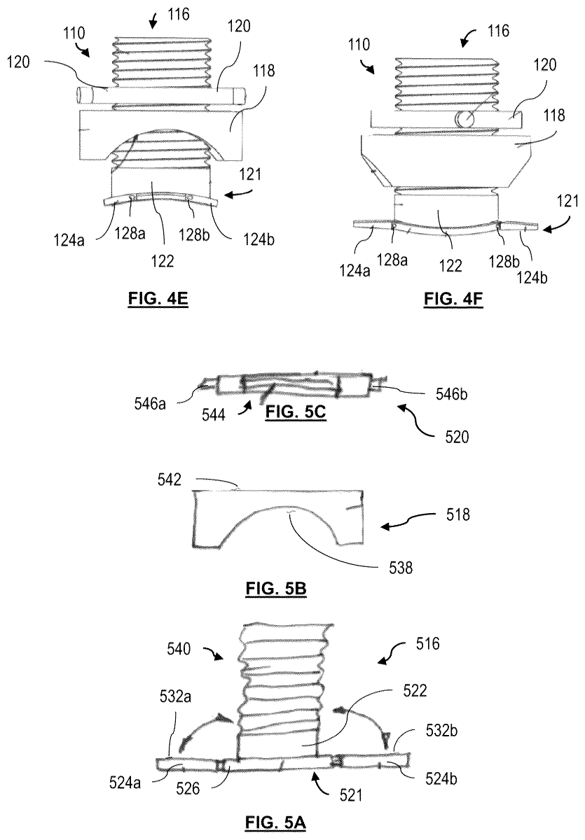

Referring also to FIGS. 4A through 4F, shown therein is a schematic of coupling 110 from a top perspective view, a bottom perspective view, a top view, a bottom view, a first side view, and a second side view, according to an embodiment.

The coupling 110 includes an insert 116. In the installed configuration, the insert 116 is partially disposed in the interior 131 of the main pipe 112.

The insert includes a coupling pipe 122. The coupling pipe 122 provides a flow conduit between the main pipe 112 and the lateral pipe 114. The coupling pipe 122 may be a rigid plastic pipe. In the installed configuration, the coupling pipe 122 at least partially extends from the outer surface 136. This extension provides a tap or port for connecting the lateral pipe 114.

The insert 116 further includes any number of anchors 124. Each anchor 124 is referred to herein generally as anchor 124, specifically as anchor 124a, 124b, etc. and collectively as anchors 124. Each anchor 124 is pivotally connected to the insert at a corresponding pivot 128. The pivot 128 are disposed at an insertion end 121 of the coupling pipe 122. Shown in FIGS. 2 through 9 and 11 are two anchors 124a and 124b. However, embodiments including one anchor 124 or three or more anchors 124 are expressly contemplated

Each anchor 124 is configured to pivot about the corresponding pivot 128. Each anchor 124 is configured to pivot between a deployed position (as shown in FIG. 1) and a retracted position (not shown). Securing the coupling 110 to the main pipe 112, further described below, may transition the anchors 124 from the retracted position to the deployed position. In the deployed position, each anchor 124 extends substantially radially from the coupling pipe 122. The extension of the anchors 124 in the deployed position are sufficient to interfere with an interior surface of the main pipe 112 in the installed configuration.

The anchors 124 are configured not to pivot past a limit in the deployed position. The limit of the pivot enables the anchors 124 to anchor the insert 116 (i.e. prevent the insert from being drawn through the opening). In some embodiments, the pivot of the anchors 124 is limited by a cam lock fitting. In these embodiments, the anchors may be locking into place by gravity.

The anchors 124 are composed of at least one material sufficiently rigid to resist forces securing the coupling 110 in the installed configuration. In some embodiments, the rigidity of the rigid anchor material is sufficient to withstand forces substantially beyond that needed to resist the securing force. This rigidity beneficially allows for tolerances in applying the securing force.

Pivotally connecting the anchors 124 to the coupling pipe 122 enables holding of the anchors 124 during installation from being lost in the interior 131 via the coupling pipe 122. It will be appreciated that pivot connections such as the connection between the anchors 124 and the coupling pipe 122 are not susceptible to the slipping of some other connections, such as interference connections. The retractability of the anchors enabled by the pivot connection further enables removal of the coupling 110. This connection beneficially mitigates the risk of losing an anchor in the main pipe 112. Holding the anchors 124 via the coupling pipe 122 is beneficially secure and mitigates obstructing installation. The pivot connection also, mitigates any need for special tools or access concerns as the coupling pipe 122 serves as the tool to hold the anchors 124 in place.

In the retracted position, each anchor 124 is disposed (i.e. folded) along the coupling pipe 122 (i.e. extended less) relative to in the deployed position. This retraction enables insertion of the insertion end 121 into the interior 131 through the opening 130. It will be appreciated, that partial retraction of the anchors 124 may be sufficient for passing the interior end 121 through the opening 130 and pivoting the anchors 124 to lie against the coupling pipe 122 may not be necessary for insertion. This partial retraction may mitigate interference concerns with the seal 118 and fastening member 120, further described below.

Referring to FIG. 5A, shown therein is side view schematic of an insert 516, according to an embodiment. The insert 516 may be an embodiment of the Insert 116 of FIGS. 1 through 9. A top surface 532a and 532b of anchors 524a and 524b, respectively are configured to conform to the interior surface 134 of the main pipe 112 FIGS. 1 through 2. In an example, the top surface 532a of the anchor 524b is curved to match the interior surface 134. Conforming the top surface 532 to the interior surface 134 increases the surface area at the interface of the anchors 534 and the interior surface 134. The increased surface area beneficially mitigates twisting of the insert 516 as a securing force is applied.

The coupling pipe 522 includes threads 540 on an exterior surface. The threads 540 are for threadingly receiving the internal threads 544 of the fastening member 520 of FIG. 5C, further described below.

In some embodiments, the insert 516 includes a flange 526. The flange 526 extends radially from the insertion end 521 of the insert 516. It will be appreciated, that the flange 526 may not be continuous. In an example, the flange 526 is disposed between and interrupted by the anchors 524. The flange 526 is fixedly connected to the coupling pipe 522. The anchors 524 may be pivotally connected to the coupling pipe 522 via the flange 526.

Referring back to FIGS. 1 through 4F, the coupling 110 further includes a fastening member 120. The fastening member 120 is configured to secure the coupling to the main pipe 112. In the installed configuration the fastening member 120 applies a force on the outer surface 136 of the main pipe 112 and a corresponding resultant (i.e. opposite force) on the insert 116. The resultant force holds the insert away from a longitudinal axis of the main pipe 112 (i.e. outward) such that the anchors 124 engage the interior surface 134. It will be appreciated that the resultant force may differ in magnitude from the force applied on the outer surface 136. It is expressly contemplated that the force applied on the outer surface 136 may be via one or more interceding parts such the seal 118 further described below.

Referring to FIG. 5C shown therein is a cross sectional schematic of a fastening member 520, according to an embodiment. The fastening member 520 may be an embodiment of the fastening member 120 of FIGS. 1 through 9. The fastening member 520 may be a nut 520. The nut 520 is configured to be received by the a coupling pipe such as the coupling pipe 522 of FIG. 5A. The nut 520 includes internal threads 544 for engaging coupling pipe threads such as the threads 542 of FIG. 5A. Rotation of the nut 520 applies the securing force described above.

The nut 520 may further includes tabs 546a and 546b. Tabs 546a and 546b provide a structure that beneficially aids rotating the nut 520 and applying the securing force. The tabs 546 may enable engagement of a tool to further tighten the nut 520. In some embodiments, the nut 520 is symmetrical with the same top and bottom configuration and flat surfaces. In some embodiments, the nut 520 is formed from a hard plastic material that is compatible with insert 516 of FIG. 5A.

Referring back to FIGS. 1 though 4F, the coupling 110 further includes a seal 118. The seal 118 is disposed, at least partially, between fastening member 120 and outer surface 136. In the deployed disposition, the fastening member 120 secures the seal 118 against the outer surface 136. Securing the seal 118 enables the watertight connection between the coupling 110 and the main pipe 112 for resisting potentially costly or hazardous leakage of the fluid from the pipe system 100.

Securing the seal 118 to the outer surface 136, enables physical and visual access to the interface of the seal 118 with the outer surface 136 and the opening 130, at least at the time of installation. This access beneficially enables inspection of the seal 118 over existing system with internal seals or hole insert seals which beneficially mitigates the risk of costly and potentially hazardous seal failures as well as avoids the actions to remedy such failures or to otherwise mitigate the risk (i.e. by premature replacement).

Securing the seal 118 to the outer surface 136, also beneficially enables various compositions, dispositions, and configurations the seal 118. It will be appreciated that these compositions, dispositions, and configurations of the seal 118 are not limited to those that enable the seal 118 to pass through the opening 130. It will also be appreciated that the seal 118 does not need to be configured to resist the full securing force because of anchoring function of the anchors 124. This increases the range of potential seals that may be used and simplifies seal 118 manufacturing. This beneficially mitigates inventory considerations in the field including enabling in-field manufacturing and configuring.

The seal 118 is composed of materials that provides a substantially water tight seal against the outer surface 136. For example, the seal 118 may be composed of semi-rigid materials that are sufficiently conformable to form a water-tight seal against main pipe 112. These materials may include hydrophilic materials.

Referring to FIG. 5B, shown therein is a side view schematic of a seal 518, according to an embodiment. The seal 518 may be an embodiment of the seal 118 of FIGS. 1 through 4F. A seal interface surface 538 of the seal 518 is configured to conform to the outer curvature 136 of the main pipe 112 of FIGS. 1 and 3. For example, the seal interface surface 538 may have a curved profile such as a semi cylindrical profile. The seal 518 may also seal against a surface of the fastening member 520 of FIG. 5C. For example, a top surface 542 the seal 518 may be flat such that the seal 518 seats against the nut 520 of FIG. 5C.

The seal 518 has an inner diameter that fits around the outer surface of the insert 516 of FIG. 5A. In some embodiments, the seal 518 is configured such that the fit between the seal 518 and the insert 516 is a slight interference fit. The slight interference fit enables the insert 516 to be inserted through the seal 518 by a user without mechanical assistance while providing a sealing contact.

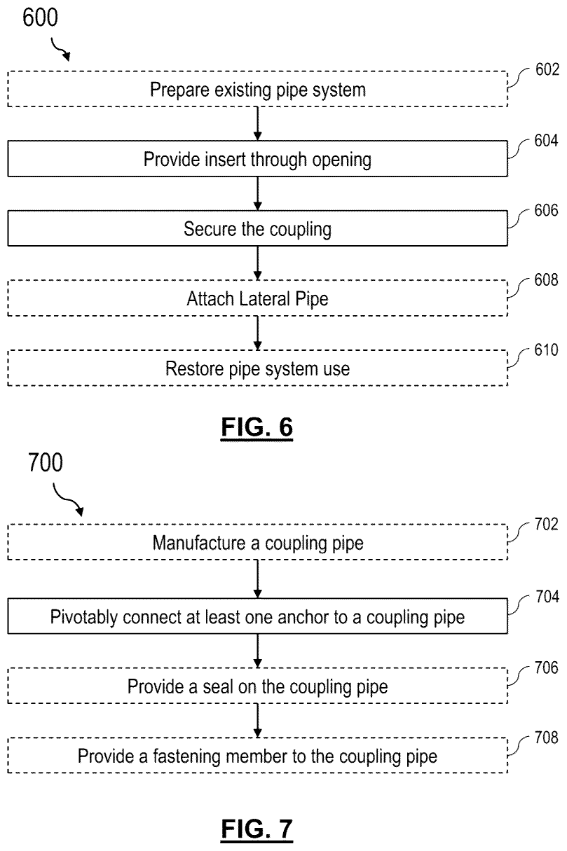

Referring to FIG. 6, shown therein is a flow diagram 600 of a method of installing a coupling, according to an embodiment. The coupling may be the coupling 10 of FIGS. 1 through 9. It will be appreciated, the that pipe system referred to herein may be the pipe system 100 of FIGS. 1 through 3.

At 602, installing the coupling may include preparing the existing pipe system to receive the coupler. The preparations may include excavating the area at an installation site to gain access to the exterior of the pipe. The preparations may also include removing contents or pressure from the pipe system such as by cutting off service to the installation site and/or draining the main pipe of its contents. A hole is provided (i.e. cut) in the main pipe to enable flow to and from the coupling once installed, to provide access to an interior of the main pipe, and to receive the coupling.

At 604, installing the coupling includes inserting, at least partially, the insert of the coupling through the hole. It will be appreciated that as the insert is inserted through the hole the anchors may contact the exterior surface of the main pipe and/or the side wall of the opening. This contact may cause the anchors to be retracted by providing a pivoting reaction force on the underside of the anchors opposite to the insertion force. Retracting the anchors via the insertion force beneficially simplifies installation and mitigates failure risk.

When the anchors clear the opening, this contact force is released. Releasing the contact force allows the anchors to deploy. It will be appreciated that the anchors will deploy at least partially from the retraction during insertion such that the anchors will interface with the interior surface of the main pipe if removing the insert is attempted. In some embodiments, the deployment upon releasing the contact force is passive or due to restorative forces from the insertion, for example gravity or spring forces. This deployment may also be active, for example via the securing force as further described below.

It will be appreciated that during insertion, the seal and fastening member of the coupling may be removably connected to the insert. In an example, the fastening member and/or seal is provided to the coupling as described at 706 and 708 of FIG. 7 below prior to insertion of the coupling in to the main pipe. While the seal and/or fastening member is disposed sufficiently longitudinally away from the pivot (i.e. the fasting member is loose) to avoid interference with the retraction of the anchors, the seal and the fastening member remain at least minimally engaged and removably connected to the insert. Leaving the fastening member removably connected to the insert during insertion beneficially provides a stop against losing the insert in the interior of the main pipe, such as if the insert is unintentionally released or dropped during installation.

At 606, installing the coupling further includes securing the coupling to the main pipe. Securing the coupling includes providing a securing force via a fastening member. In an example, the fastening member is a nut. The fastening member is provided to the insert. Specifically threads on an exterior of the insert are engaged by internal threads of the nut. The nut is rotated to shorten the gap between the nut and the anchors. As the gap is shortened, the insertion end of the coupling insert is drawn outward (i.e. away from an axis of the main pipe) As the coupling insert is drawn outward the anchors contact the interior surface of the main pipe. Where the anchors are not fully deployed, the contact forces the anchors into the deployed position. Retracting the anchors, at 604, and deploying the anchors at 606 via contact with the main pipe avoids the need for actions, tools, or anchor compositions and configurations generally for or dedicated to executing these functions. Avoiding such elements beneficially reduces costs and mitigates inventory and equipment concerns particularly in the field where space and transport costs are at a premium.

Securing the coupling includes forming the watertight seal. It will be appreciated that a seal is provided between the fastening member and the outer surface of the main pipe prior to securing the coupling. For example, a seal is be provided to the coupling pipe, further described at 706 of FIG. 7. Tightening the fastening member, such as by rotating the nut, forces the seal against the outer surface of the main pipe. This force and the configuration, composition, and disposition of the seal provide the watertight seal.

At 608, installing the coupling may further include attaching a lateral pipe to the outward extending part of the coupling pipe. The attachment may be any suitable method such as via threads of the coupling pipe or a quick connect mechanism. It will be appreciated that the coupling may be rendered inoperable such as via a cap or valve where the coupling is installed in contemplation of potential later use. Future uses may include attaching a lateral pipe or fixture or accessing the main pipe such for extracting from or providing material to the main pipe.

At 610, installing the coupling may include restoring service to the pipe system. For example, water or sewage services stopped upstream from the coupling may be reinitiated.

Referring to FIG. 7, shown there is a flow diagram of manufacturing a coupling, according to an embodiment. The coupling may be the coupling 10 of FIGS. 1 thorough 9.

At 702, manufacturing the coupling may include manufacturing a coupling pipe. For example, threads may be cut on the outside of pipe to receive a nut type fastening member. The threads may only be a section of the pipe sufficient provide the a structure for tightening the fastening member. The pipe may be provided with a flange for attaching the anchor to the pipe, further described below.

At 704, manufacturing the coupling includes pivotably connecting at least one anchor to a coupling pipe of an insert of the coupling. The anchor is connected in a disposition between a retracted position and a deployed position, inclusively, as described above. The attachment may be via a flange. The pivotable connection secures the anchor to the coupling pipe such that when the coupling pipe is held, inserted into a main pipe or a securing force is applied to the anchor, the anchor remains attached to coupling pipe.

At 706, may further include providing a seal to the coupling. In an example, an insert of the coupling is provided through a corresponding hole in the seal. In a further example, a portion of the insert between a fastening member and the anchors and/or main pipe exterior surface is passed through a slit in the seal. It will be appreciated that the passing of the insert through a seal slit is describe as a relative motion and the coupling could also be passed through the seal slit. The coupling configuration and installation beneficially enables seals that are not continuously connected (i.e. a seal with a slit).

It will be appreciated that the coupling does not necessarily rely on the seal to provide anchoring. This beneficially mitigates the need for seals that are specialized in configuration or composition to resist securing forces. In addition to mitigating materials supply concerns, this beneficially avoids the need for specialized manufacturing of the seal. In some embodiments, this may enable manufacturing the seal in the field with on hand tools and stock materials. This also allows for seal configurations such as the split seal that enable providing the seal to the coupling at various times including after a fastening member is provided to the coupling, as further described at 706 below. It is expressly contemplated that providing the fastening member may be completed prior to or after the coupling has been inserted into the main pipe, for example at installation in the field.

At 706, manufacturing the coupling may further include providing a fastening member to the coupling. For example, where the fastening member is a nut with corresponding threads to the coupling pipe, the nut maybe provided to engage threads of the coupling pipe rotations significant to secure the nut on the coupling pipe may be made. It will be appreciated that providing the fastening member may be completed prior to and/or after the coupling has been inserted into the main pipe, for example at installation in the field. The fastening member may not be fully engaged (i.e. tightened) to avoid interference of the anchors with the fastening and the seal.

Accordingly, the disclosed coupling provides for the connection of a lateral pipe to a main pipe entirely from the outer surface of the main pipe.

While the above description provides examples of one or more apparatus, methods, or systems, it will be appreciated that other apparatus, methods, or systems may be within the scope of the claims as interpreted by one of skill in the art.

What is claimed is:

1. A coupling for providing a tap off a main pipe, the coupling comprising:
an insert for, in an installed configuration, being partially disposed in an interior of the main pipe, the insert comprising:
a coupling pipe for providing a flow conduit off the main pipe; and
an anchor pivotably connected to the coupling pipe at a pivot located at an insertion end of the coupling pipe, the anchor configured to retract to a retracted configuration when inserted through an opening in the main pipe and deploy to a deployed configuration after the anchor is inserted past the opening and
wherein in the deployed configuration the anchor extends radially from the coupling pipe and a profile of the coupling pipe at the insertion end comprising the anchor in the deployed configuration is greater than the profile of the opening in at least one dimension, the larger profile of the insertion end engaging an interior surface of the main pipe at the anchor when drawn outward by a securing force, the engagement anchoring the coupling to the main pipe and
wherein the at least one anchor is sufficiently rigid and fixed from pivoting past the deployed configuration to withstand forces for anchoring the coupling to the main pipe.

2. The coupling of claim 1 further comprising:
a fastening member for providing a force for securing the coupling to the main pipe wherein the securing force draws the insert outward from the main pipe such that the at least one anchor engages the interior surface of the main pipe; and
a seal for sealing the connection between coupling and the main pipe, the seal in an installed configuration sealing the opening and disposed at least partially between the fastening member and the main pipe and held tight against the main pipe by the fastening member.

3. The coupling of claim 1, wherein the insert further comprises a flange and wherein the pivotable connection of the at least one anchor to the coupling pipe is via the flange.

4. The coupling of claim 2, wherein the coupling pipe comprises external threads and the fastening member comprises a nut with internal threads corresponding to the external threads of the coupling pipe for threadingly engaging the coupling pipe.

5. The coupling of claim 4, wherein the nut comprises at least one tab.

6. The coupling of claim 1, wherein a top surface of the at least one anchor is curved.

7. The coupling of claim 2, wherein a surface of the seal that interfaces with the main pipe is configured with a profile to conform to the main pipe.

8. A method of installing coupling on a main pipe of a pipe system, the method comprising:
inserting an insertion end of an insert of a coupler via a coupling pipe through an opening of the main pipe at least until at least one anchor of the insert pivotally connected to coupling pipe clears the opening, wherein the opening is sized to accommodate the insertion end of the insert with the anchors in a retracted configuration and wherein the insertion of insert transitions any anchors not in a retracted configuration to the retracted configuration via contact with the main pipe; and
securing, by a fastening member, the coupler to the main pipe wherein the securing of the coupler establishes a fluidic, fixed, and sealed connection between the main pipe and the coupler, the securing comprising:
drawing the coupler outward from the main pipe to an installed configuration wherein in the installed disposition the at least one anchor in a deployed configuration engages an interior surface of the pipe for resisting the removal of the coupler from the main pipe and wherein contact from drawing the coupler outward of nondeployed anchors of the at least one anchor with the interior of the main pipe deploys the nondeployed anchor to the deployed configuration and wherein the opening is smaller in at least on dimension than a profile of the insertion end the insert with the anchors in the deployed configuration; and
fastening the fastening member for fixing the coupler in the installed configuration.

9. The method of claim 8, wherein fastening the fastening member draws the coupler outward to the installed configuration.

10. The method of claim 8 further comprising loosening the fastening member for disposing the fastening member away from the at least one anchor to enable the anchor to retract sufficiently to clear the opening.

11. The method of claim 8 further comprising providing a seal to the coupler between the at least one anchor and the fastening member and wherein fastening the fastening member holds the seal tight against an exterior surface of the pipe.

12. The method of claim 8 further comprising:
removing, where access to the main pipe is obstructed, the obstruction;
stopping service to the pipe system at a site of the coupling installation; and
providing the opening in the main pipe.

13. The method of claim 8 further comprising attaching one or more of a later pipe, a cap, a valve and a fixture to the coupling pipe.

14. The method of claim 8 further comprising restoring service to the pipe system at a site of the coupling installation.

15. A method of manufacturing a coupling for providing a tap off a main pipe, the method comprising pivotably attaching at least one anchor to an insertion end of an insert of the coupling the insert comprising:
a coupling pipe for providing a flow conduit off the main pipe; and
at least one anchor pivotably connected to the coupling pipe at a pivot located at an insertion end of the coupling pipe, the anchor configured to retract to a retracted configuration when inserted through an opening in the main pipe and deploy to a deployed configuration after the at least one anchor is inserted past the opening and
wherein in the deployed configuration the at least one anchor extends radially from the coupling pipe and a profile of the coupling pipe at the insertion end based on the extended anchor is greater than the profile of the opening in at least one dimension such that removal of the insert from the main pipe is impeded by the at least one anchor engaging an interior surface of the main pipe and
wherein the opening is sized to accommodate the insertion end of the insert with the anchors in a retracted configuration and smaller in at least on dimension than a profile of the insertion end the insert with the anchors in the deployed configuration and
wherein the at least one anchor is sufficiently rigid and fixed from pivoting past the deployed configuration to withstand forces for securing and sealing the coupling to the main pipe for anchoring the coupling within the pipe.

16. The method of claim 15 further comprising providing the insert with a flange at the insertion end, wherein the at least one anchor is pivotably connected to the coupling pipe via the flange.

17. The method of claim 15 further comprising providing a fastening member to the coupling and providing a seal disposed at least partially between the at least one anchor and the fastening member.

18. The method of claim 17, wherein the fastening member is a nut comprising internal threads, the method further comprising threading the coupling pipe with external threads corresponding to the internal threads.

19. The method of claim 17 further comprising configuring the fastening member to conform to an exterior surface of the main pipe.

20. The method of claim 19, wherein configuring the seal comprises removing material from a stock seal material such that an interface surface of the seal has a curved profile corresponding to the exterior surface of the main pipe.
